(19) United States
(12) Patent Application Publication
(10) Pub. No.: US 2013/0155233 A1
(43) Pub. Date: Jun. 20, 2013

(54) MONITORING CAMERA

(71) Applicant: Axis AB, Lund (SE)

(72) Inventors: Christian DAHLQVIST, Loberod (SE); Henrik PERSSON, Lund (SE); Magnus GRUFFMAN, Vellinge (SE); Jan RYZAK, Malmo (SE)

(73) Assignee: AXIS AB, Lund (SE)

(21) Appl. No.: 13/720,378

(22) Filed: Dec. 19, 2012

Related U.S. Application Data
(60) Provisional application No. 61/578,005, filed on Dec. 20, 2011.

(30) Foreign Application Priority Data
Dec. 19, 2011 (EP) 11194234.8

(51) Int. Cl. H04N 5/225; H04N 7/18

(52) U.S. Cl. CPC H04N 5/225; H04N 7/18
USPC 348/143

(57) ABSTRACT

A camera and a method is used for monitoring a scene, the camera having a camera lens and an illumination device arranged to create an illumination pattern for illuminating the scene. The illumination device comprises at least one light source and a plurality of light guiding elements mounted in a plurality of mounting positions essentially along the circumference of the camera lens. The light guiding elements direct light emitted from the at least one light source in a respective direction unobscured by the camera lens to create essentially mutually complementary parts of the illumination pattern.

### CROSS REFERENCE TO RELATED APPLICATIONS

This application claims the benefit of European Patent Application No. 11194234.8 filed Dec. 19, 2011 and U.S. Provisional Patent Application No. 61/578,005 filed Dec. 20, 2011, which are incorporated by reference as if fully set forth.

### TECHNICAL FIELD

The present invention relates to a camera for monitoring a scene and to a method of illuminating a scene monitored by a camera.

### BACKGROUND ART

Surveillance cameras used to monitor a specific setting may from time to time need additional lighting to be able to give a good picture of the environment that they are used to monitor. This is for instance the case during night time in an outdoor setting when the natural light is insufficient for the camera. Some type of lighting can then be used in combination with the surveillance camera. A common choice is to use light emitting diodes, LEDs, emitting infrared or white light, for illuminating the scene which is monitored by the surveillance camera. The LEDs may be mounted in external units or can be integrated in the camera housing or the camera's mechanical structure.

In order to allow the camera to produce images of good quality, it is of interest to be able to provide a uniform illumination of the setting.

U.S. Pat. No. 7,738,033 discloses an illumination device for a monitoring camera with a plurality of light devices arranged along an arc around the monitoring camera. The main emission direction of each light device is directed outwards from the monitoring camera, intersecting the optical axis of the camera. According to U.S. Pat. No. 7,783,033, this arrangement of light devices provides uniform illumination of a monitoring region in front of the monitoring camera.

### SUMMARY

An essentially even or uniform illumination of a scene monitored by a camera is provided while at the same time reducing power consumption and heat generation.

In particular, according to a first aspect, a camera for monitoring a scene comprises a camera lens and an illumination device arranged to create an illumination pattern for illuminating the scene, wherein the illumination device comprises at least one light source and a plurality of light guiding elements mounted in a plurality of mounting positions essentially along the circumference of the camera lens. The light guiding elements are arranged to direct light emitted from the at least one light source, in a respective direction unobscured by the camera lens, to create essentially mutually complementary parts of the illumination pattern.

According to another aspect, a method of illuminating a scene monitored by a camera comprises the steps of:

arranging a plurality of light guiding elements in a corresponding plurality of mounting positions essentially along the circumference of a camera lens, and

directing light, by means of the light guiding elements, emitted from at least one light source, in a respective direction unobscured by the camera lens, to create essentially mutually complementary parts of an illumination pattern for illuminating the scene.

Each light guiding element may be associated with a respective light source. This would provide a simplified installation as no fibers or similar would have to be provided to transfer light from the light source to the light guiding elements.

The illumination device may comprise two light guiding elements. The illumination pattern could then be circular and the mutually complementary parts essentially complementary semicircles. As an alternative, the illumination pattern could be rectangular and the mutually complementary parts essentially complementary rectangular halves of the rectangular illumination pattern. Both of these options present simple and efficient ways of creating an even illumination of a scene.

In order to create the circular or rectangular halves, the mounting positions of the light guiding elements may advantageously be 180° apart from each other along the circumference of the camera lens.

An additional light guiding element may be arranged to create an additional illumination pattern in front of the camera lens, the additional illumination pattern essentially encompassing a center axis of the camera lens. This provides a way of enhancing the illumination in the center of the image, which would be useful for instance when monitoring a door leading to a hallway and the surroundings thereof. This additional illumination pattern may also be combined with providing the illumination pattern in the shape of a hollow frame surrounding the additional illumination pattern. In other words, the illumination pattern is provided in the form of an illuminated frame which contains or surrounds or encloses a hollow, non-illuminated pattern, which in turn correlates with the additional illumination pattern in the form of an illuminated center pattern. This could enhance the possibilities of providing an even illumination to the monitored scene. The hollow illumination pattern combined with an additional illumination pattern would typically be useful when illuminating an area of the scene fairly close to the camera, where the inner additional illumination pattern may be created without being obscured by the camera lens. This variant is also useful for adjusting and improving the light pattern according to changes in the scene when the camera shifts zoom.

The output light intensity from the light guiding elements may be controllable to give the opportunity to adapt the illumination provided to scenes at varying distances and in varying light conditions.

At least one of the light guiding elements may comprise a lens, which gives an efficient way of directing the light from the light source. Additionally or alternatively, at least one of the light guiding elements may comprise a wave guide, which also would be an efficient way of directing the light from the light source.

At least one of the light guiding elements may comprise a mirror surface arranged for reflecting incident light in a direction of the respective portion of the illumination pattern. This would provide an easy and efficient way of making sure that all light is directed to the desired part of the illumination pattern.

The at least one light source is arranged for emitting IR-radiation. The term IR-radiation in this case would also include radiation emitted in the near-infrared spectrum. This makes it possible to use the illumination device to provide illumination for an IR-camera, which e.g. may be advantageous during night time.

The at least one light source may comprise an LED, being an energy and space efficient alternative. A LED with a comparatively high light output may be particularly advantageous in case only a few light sources are used.

The camera may comprise a dome having a transparent dome surface, and the camera lens and the plurality of light guiding elements are then mounted inside the dome. The dome provides protection for the camera and the illumination device, but also introduces physical restraints for the placing of the illumination device. An even illumination of the scene then may be provided when the light guiding elements must be placed below the edge of the camera lens due to the shape of the dome.

A further scope of applicability of the embodiments will become apparent from the detailed description given below. However, it should be understood that the detailed description and specific examples are given by way of illustration only, since various changes and modifications within the scope of the invention will become apparent to those skilled in the art from this detailed description. Hence, it is to be understood that this invention is not limited to the particular component parts of the device described or steps of the methods described as such device and method may vary. It is also to be understood that the terminology used herein is for purpose of describing particular embodiments only, and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a sensor” or “the sensor” may include several devices, and the like. Furthermore, the word “comprising” does not exclude other elements or steps.

### BRIEF DESCRIPTION OF THE DRAWINGS

The embodiments will now be described in more detail by way of example and with reference to the accompanying schematic drawings, in which:

FIG. 1 shows a scene monitored by a camera.

FIG. 2 shows the camera of FIG. 1 in a more detailed side view.

FIG. 3 shows the camera in a front view.

FIG. 4 shows an illumination pattern.

FIG. 5 shows part of an illumination device.

FIG. 6-8 shows different illumination patterns.

FIG. 9 shows an alternative camera embodiment in a front view.

FIG. 10 shows an illumination pattern.

FIG. 11 illustrates a method according to an embodiment.

### DETAILED DESCRIPTION

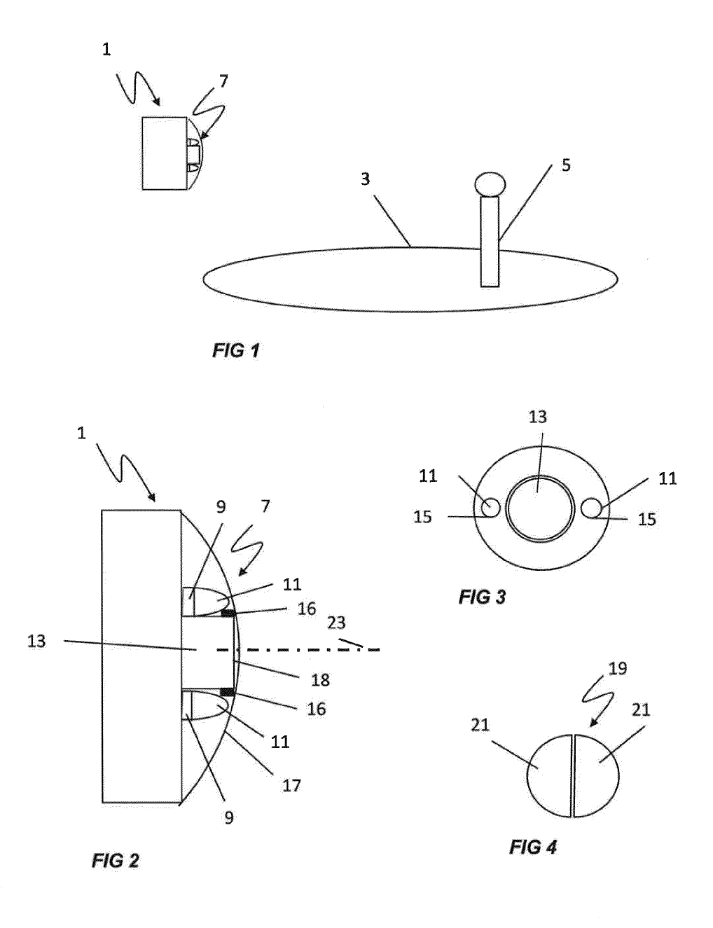

In FIG. 1, a camera 1 is shown which monitors a scene 3, where objects 5 may appear. The camera 1 can be a fixed focus surveillance camera, or a varifocal surveillance camera, which is able to adapt its focus to objects at varying distances from the camera. In the case of a varifocal camera, this may or may not have zooming capabilities, and the zoom may be either manually or electrically controlled.

As is shown in more detail in FIGS. 2 and 3, the camera 1 has integrated lighting in the form of an illumination device 7, which in turn comprises at least one light source 9, e.g., in the form of a LED, and a plurality of light guiding elements 11. In the exemplifying embodiment shown in FIGS. 2 and 3, the illumination device 7 comprises two light sources 9 and two light guiding elements 11. The camera 1 further comprises a camera lens 13 which can be moved in a pan or tilt fashion to provide coverage to different part of the scene 3.

The light guiding elements 11 are mounted in mounting positions 15 essentially along the circumference of the camera lens 13, as shown in FIG. 3. The wording “essentially along the circumference of the camera lens” may be interpreted as not on the camera lens 13 itself, but next to or with a small spacing of e.g. a couple of millimeters or more between the camera lens 13 and the light guiding elements 11. In the case of two light guiding elements, these may be place 180° apart from each other along the circumference of the camera lens.

In FIGS. 1 and 2, the light sources 9 are mounted directly beneath the light guiding elements 11, next to the camera lens 13. It would also be possible to use one single light source mounted in a position behind the camera lens 13, and guide the light from that light source through fibers to the light guiding elements 11. In such case, these fibers may be considered to form part of the light guiding elements 11.

The output intensity of the one or more light sources 9 may be controllable, i.e. the output intensity may be varied for each of the light sources 9, either in groups or clusters or separately per light source 9. As an alternative, the output light intensity of all of the provided light sources may be jointly controlled. In this way it is possible to provide a zoomable illumination which can be adapted to a zoom facility in the camera 1 such that in a tele-zoom setting a higher output intensity is provided than in a wide zoom setting. The amount of illumination can also be adapted depending on the ambient light so that more light is provided in a darker setting.

The light sources 9 may be emitting light in the visible or non-visible spectrum, as one example they may be designed for emitting in the infra-red or near infra-red (approximately 850 nm) spectrum, and it may be noted that both for visible and non-visible radiation, LEDs are just one example of light emitting elements which could be used. Other possible choices include but are not limited to light bulbs, halogen lamps and gas discharge lamps.

The camera lens 13 is mounted inside a the transparent surface of a semi-spherical dome 17 together with the light guiding elements 11, and, in the example of FIG. 2, the light sources 9. The surface of the dome 17 is made of a material which provides physical protection for the camera lens 13 and the light guiding elements 11, e.g. against manipulation attempts by an intruder, and which at the same time allows light to pass, both from the light guiding elements 11 to the scene 3 and from the outside of the dome 17 to the camera lens 13 so that images may be captured by the camera 1.

In addition to providing protection to the camera lens 13 and the light guiding elements 11, the dome 17 creates restraints when it comes to the mounting of the illumination. The camera lens 13 needs to be placed in close proximity to the dome surface to avoid reflections which could lower the quality of images. In addition, a rubber seal or gasket 16 may be provided surrounding the camera lens 13 and creating additional protection against reflections of light in the inside of the dome 17 entering the camera lens 13. In either case, this means that there is no room to place the light guiding elements in line with the camera lens 13. Due to the semi-spherical shape of the dome 17, the illumination has to be provided from positions below the edge 18 of the camera lens 13. However, the light guiding elements 11 should be placed in close proximity to the camera lens so that the illumination may follow the movement of the camera lens 13 inside the dome 17 and provide illumination for the scene currently being monitored by the camera 1, i.e., in the direction in which the camera lens 13 is pointing.

The illumination device 7 is arranged to create an illumination pattern for illuminating the scene 3. In FIG. 4, an exemplifying illumination pattern 19 in the form of a circle is shown. In the embodiment having two light guiding elements 11, each of these is arranged to create a semicircular portion 21 of the illumination pattern 19. In this way, the light guiding elements 11 each create essentially mutually complementary parts or portions of the total illumination pattern. In this way, it is possible to create an even illumination pattern without being disturbed by the edge 18 of the camera lens 13. It may be noted that the term “essentially” here means that the illumination pattern parts 21 created by the different light guiding elements 11 in principle do not overlap and do not have any substantial gaps between them, but instead an even illumination of the scene or a desired part of the scene is created, where the entire illumination pattern 19 has in principle the same light intensity, with only minor fluctuations, not noticeable to the camera 1 capturing images of the illuminated scene 3.

The wording “mutually complementary” here means that the portions or parts together add up to form the total illumination pattern, without any major overlaps or gaps, such as in the example in FIG. 4 where the two semicircles 21 together form the circular illumination pattern 19. In FIG. 4, a small distance is shown between the two semicircles for illustrational purposes. However, in practice a small overlap of some millimeters may be tolerated and even preferred so that no darker areas where no illumination is provided exists.

Another way of describing the situation is that each illumination pattern portion 19 is created essentially on the same side of the camera lens 13 as the mounting position 15 of the respective light guiding element 11 itself. As such, light is not directed towards the side or edge of the camera lens 13, or in other directions where it would not be useful, but instead essentially all of the light from the light sources 9 is guided by each light guiding element 11 to create the desired illumination pattern 19. Alternatively, this may also be described as the light from each light guiding element 11 not crossing a center line 23 of the camera lens 13, and being provided in essentially the same direction as the center line 23.

By using the illumination device described herein, portions of the desired illumination pattern 19 which are not possible to create or reach by one light guiding element 11, due to the camera lens 13 or other obstacle being placed in the light path of that light guiding element giving it a limited range, are created by a second (or as it may be a third or fourth and so forth) light guiding element 11. This second light guiding element 11 creates a complementary illumination pattern part, which, together with the part created by the first light emitting element 11, completes the illumination pattern 19. As described above, the light guiding elements are mounted next to and slightly below the edge of the camera lens, meaning that without the light guiding elements creating the mutually complementary portions of the illumination pattern as described, the camera lens would obstruct the part of the light from the light guiding elements which is directed towards the center line of the camera lens. According to an embodiment, this light is instead made useful by being directed by the light guiding elements towards the relevant portion of the illumination pattern.

Going more into detail of the light guiding elements 11, these may be for example in the form of a lens or in the form of a light guide. A mirror or other element providing a similar functionality may be provided to reflect light incident from the light source to such a direction that it contributes to create the desired portion of the illumination pattern. In FIG. 5, an example of a light guiding element 11 and a light source 9 are shown which may be used to create the semicircular illumination pattern portions 21 of FIG. 4. The light source in FIG. 5 is in the form of an LED, and the light guiding element is in the form of a lens shaped as a quarter of a sphere 27, having a mirror 29 on one side. The lens is mounted such that the backside of the mirror 29 is facing the side of the camera lens 13, which has the effect that light incident on the mirror 29, from the light source 9, in the direction towards the side of camera lens 13, is reflected back into the lens and can be directed to create the desired portion of the illumination pattern 19.

As an alternative to the lens with a mirror shown in FIG. 5, a lens not having a mirror, a wave guide with a mirror or without a mirror or any other type of optical element being capable of creating a desired part of the illumination pattern may be used as light guiding elements 11. The different alternatives may also be combined in any suitable manner, e.g., such that a LED with a lens is creating a first portion of the illumination pattern and a complementary second portion is created by a wave guide directing light from a light source mounted beneath the camera lens.

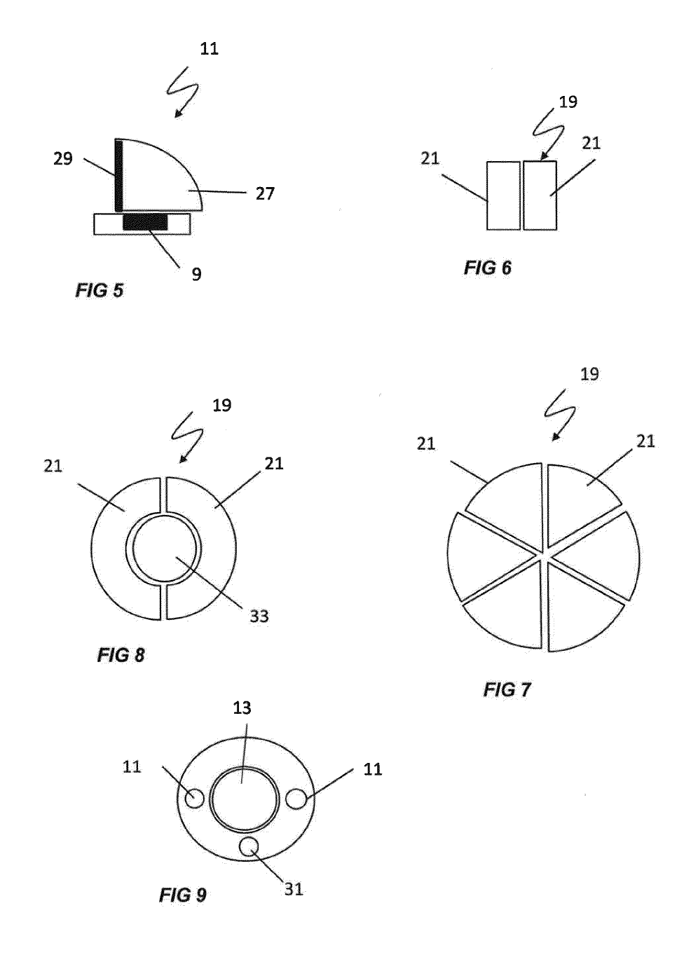

In FIG. 6, another variant of an illumination pattern 19 is shown which is built up by two complementary rectangles 21, together forming a desired square or rectangular illumination pattern. The light guiding elements creating such a pattern may be placed in similar positions as the light guiding elements 11 shown in FIGS. 2-3, but instead of being arranged to create semicircular portions of the illumination pattern, the light guiding elements would in this case comprise a lens, a light guide or other optical element that is able to direct light from the light source(s) 9 to create a rectangular pattern.

Yet another example of an illumination pattern 19 is shown in FIG. 7. The complementary parts 21 of the illumination pattern 19 are, in this case, shaped as sectors of a circle. For the illumination pattern shown in FIG. 7 comprising six sector shaped parts, each of these parts could be created by a separate light guiding element 11.

A further variant of an illumination pattern created by a camera having an illumination device according to an embodiment is shown in FIG. 8. This illumination pattern is in the form of a hollow frame having two parts 21. More parts could also be a possibility. The illumination device shown in FIG. 9 could in this case comprise an additional light guiding element 31, which is arranged to create an additional illumination pattern 33 in front of the camera lens and which encompasses the center line 23 of the camera lens 13, i.e., filling the area within the hollow frame 19. In the case of a circular hollow frame, the additional illumination pattern 33 would suitably be circular too.

It would also be possible, for example, to create a hollow rectangular frame built from two or more illumination pattern parts and fill that frame with a rectangular additional illumination pattern. The hollow or frame-shaped illumination pattern could also be used without the additional illumination pattern filling the area within the frame, in case that would be of interest to a user of the monitoring system.

The hollow illumination pattern combined with an additional illumination pattern would typically be useful when illuminating an area of the scene fairly close to the camera, where the inner circular illumination pattern 31 may be created without being obscured by the camera lens 13.

As yet another option, the additional illumination pattern 33 may also be combined with the illumination pattern 19 of FIG. 4, FIG. 6 or FIG. 7 such that additional illumination is provided to a center part of the illumination pattern 19. This would be useful for example when the camera 1 is monitoring a room with a door opening to a hallway in the center of the images captured by the camera. It may then be advantageous to be able to provide additional illumination in the center of the images so that the hallway is properly illuminated.

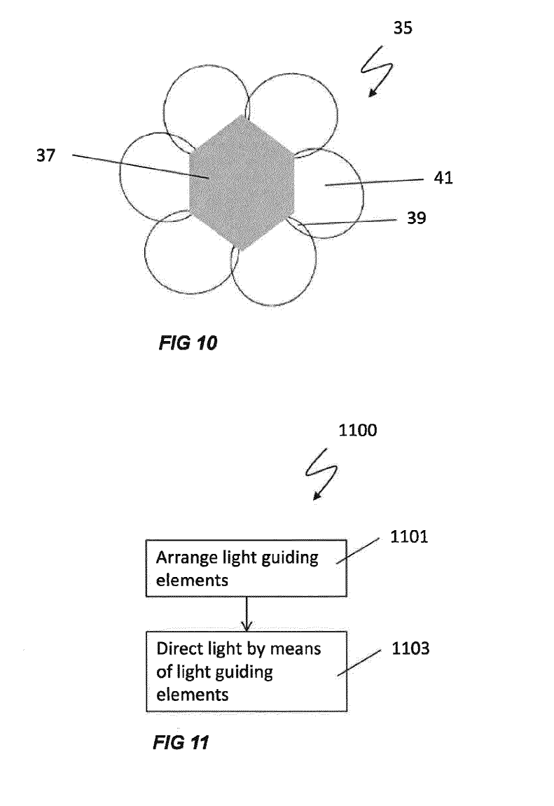

It may be illustrative to compare with a situation where no light guiding elements 11 are provided which guide the light to create mutually complementary parts 21 of an illumination pattern 19, but where light sources instead each provide light in circular fashion, e.g., in the form of a number of around twenty LEDs mounted around and next to the camera lens. The total illumination pattern provided by such LEDs would then be partly overlapping circles, or more correctly, partly overlapping, partially obscured circles. This would be the case since part of the light from each of the LEDs would be lost as it is directed towards the camera lens, thus creating a disturbance in the circle provided by that LED. The lighting provided by such an arrangement would be uneven, having brighter areas where the circles are overlapping and dark areas where the light from a LED is hindered by the side of the camera lens to reach the scene. FIG. 10 schematically illustrates such an uneven light pattern 35 having a darker area 37 in the middle where the camera lens gets in the way for the light from the LEDs. The brighter areas 39 would occur where the circles 41 are overlapping. For illustrational purposes, only six circles 41 are shown. The areas outside of the circles 41 would also be dark for obvious reasons. However, for illustrational simplicity, this is not shown in the drawing.

In FIG. 11, a method 1100 according to an embodiment is illustrated. In a first step 1101, a plurality of light guiding elements are arranged in a corresponding plurality of mounting positions essentially along the circumference of a camera lens. In step 1102, light emitted from at least one light source is directed by means of the light guiding elements in a respective direction unobscured by the camera lens, to create essentially mutually complementary parts of an illumination pattern for illuminating the scene. In other words, each part or portion of the illumination pattern is created essentially on a same side of the camera lens as the corresponding mounting position of the respective light guiding element.

1. A camera for monitoring a scene, the camera having a camera lens and an illumination device arranged to create an illumination pattern for illuminating the scene, the illumination device comprising:
at least one light source; and
a plurality of light guiding elements mounted in a plurality of mounting positions essentially along the circumference of the camera lens;
wherein the light guiding elements are arranged to direct light emitted from the at least one light source, in a respective direction unobscured by the camera lens, to create essentially mutually complementary parts of the illumination pattern.

2. The camera of claim 1, wherein each light guiding element is associated with a respective light source.

3. The camera of claim 1, wherein the illumination device comprises two light guiding elements, the illumination pattern is circular and the mutually complementary parts are essentially complementary semicircles.

4. The camera of claim 1, wherein the illumination device comprises two light guiding elements, the illumination pattern is rectangular and the mutually complementary parts are essentially complementary rectangular halves of the rectangular illumination pattern.

5. The camera of claim 3, wherein the mounting positions of the light guiding elements are 180° apart from each other along the circumference of the camera lens.

6. The camera of claim 1, further comprising an additional light guiding element arranged to create an additional illumination pattern in front of the camera lens, the additional illumination pattern essentially encompassing a center line of the camera lens.

7. The camera of claim 6, wherein the illumination pattern is in the shape of a hollow frame surrounding the additional illumination pattern.

8. The camera of claim 1, wherein output light intensity from the light guiding elements is controllable.

9. The camera of claim 1, wherein at least one of the light guiding elements comprises a lens.

10. The camera of claim 1, wherein at least one of the light guiding elements comprises a wave guide.

11. The camera of claim 1, wherein at least one of the light guiding elements comprises a mirror surface arranged for reflecting incident light in a direction of the respective part of the illumination pattern.

12. The camera of claim 1, wherein the at least one light source is arranged for emitting IR-radiation.

13. The camera of claim 1, wherein the at least one light source comprises an LED.

14. The camera of claim 1, wherein the camera comprises a dome having a transparent dome surface, and wherein the camera lens and the plurality of light guiding elements are mounted inside the dome.

15. A method of illuminating a scene monitored by a camera, comprising:
arranging a plurality of light guiding elements in a corresponding plurality of mounting positions essentially along the circumference of a camera lens; and
directing light, by the light guiding elements, emitted from at least one light source, in a respective direction unobscured by the camera lens, to create essentially mutually complementary parts of an illumination pattern for illuminating the scene, such that each part of the illumination pattern is created essentially on a same side of the camera lens as the corresponding mounting position of the respective light guiding element.
